(19) United States
(12) Patent Application Publication
(10) Pub. No.: US 2025/0027907 A1
(43) Pub. Date: Jan. 23, 2025

(54) WIRELESS MULTIFUNCTIONAL HARSH ENVIRONMENT SENSOR DEVICE

(71) Applicant: UNIVERSITY OF NORTH TEXAS, Denton, TX (US)

(72) Inventor: Haifeng Zhang, Denton, TX (US)

(21) Appl. No.: 18/775,505

(22) Filed: Jul. 17, 2024

Related U.S. Application Data
(60) Provisional application No. 63/513,917, filed on Jul. 17, 2023.

(51) Int. Cl. G01N 29/02; G01N 29/24

(52) U.S. Cl. CPC G01N 29/022; G01N 29/2437; G01N 2291/021

(57) ABSTRACT

A wireless multifunctional harsh environment monitoring device can include a housing. The device can include a dumbbell-shaped crystal structure within the housing, where the dumbbell-shaped crystal structure includes a top disk, a bottom disk and a center bar between the top disk and the bottom disk. The device can include a plurality of gas detection systems having one component exposed on a surface of the top disk of the dumbbell-shaped crystal structure and open to an open top of the housing. The device can also have a pressure and temperature sensing mechanism attached to the center bar of the dumbbell-shaped crystal structure. The pressure and temperature sensing mechanism can simultaneously detect pressure and temperature from gases exposed to the surface of the top disk.

### CROSS-REFERENCE TO RELATED APPLICATION

This application claims priority to, and the benefit of, U.S. Provisional Patent Application 63/513,917 entitled “WIRELESS MULTIFUNCTIONAL HARSH ENVIRONMENT SENSOR DEVICE” which was filed on Jul. 17, 2023, and is incorporated by reference as if set forth herein in its entirety.

### BACKGROUND

High temperature environments, caustic environments, radioactive environments, and other harsh environments can present challenges to current sensing and instrumentation technologies. Harsh environments can require monitoring in order to ensure safe operation of equipment and industrial processes, and the environments themselves can be harmful for sensors. Oxy-fuel combustion is a carbon capture technology that involves burning fuel in a mixture of oxygen and recycled flue gas at high temperatures and pressures. Sensing parameters in this and other harsh, high temperature, caustic, gaseous environments can be impractical or impossible to monitor using traditional sensors. As a result, there is a need for improvements in monitoring and sensing technologies in these applications, among others.

### BRIEF DESCRIPTION OF THE DRAWINGS

Aspects of the present disclosure can be better understood with reference to the following drawings. It is noted that the elements in the drawings are not necessarily to scale, with emphasis instead being placed upon clearly illustrating the principles of the embodiments. In the drawings, like reference numerals designate like or corresponding, but not necessarily the same, elements throughout the several views.

FIG. 1 illustrates an example boiler system that includes a wireless multifunctional harsh environment monitoring device, according to various embodiments described herein.

FIG. 2 illustrates a harsh environment monitoring system with a wireless multifunctional harsh environment monitoring device, according to various embodiments described herein.

FIG. 3 is a drawing depicting a computing device for one or more of the components of the harsh environment monitoring system, according to various embodiments described herein.

### DETAILED DESCRIPTION

The present disclosure relates to systems, methods, and devices for wireless multifunctional harsh environment monitoring. Traditional techniques can be impractical, inefficient, and slow. Harsh environment technologies present a number of challenges. The present disclosure describes mechanisms that monitor gas presence as well as temperature and pressure in harsh environments.

The mechanisms can include a wireless passive multifunctional surface acoustic wave (SAW) monitoring device that detects gases, pressure, and temperature. The wireless multifunctional harsh environment monitoring device can operate at high-temperatures (e.g., 700° to 800° C.), and in harsh environment conditions that can include high temperature, caustic, gaseous environments. The wireless multifunctional harsh environment monitoring device can simultaneously detect three or more gas types (CO, CO₂ and O₂), as well as simultaneously detecting temperature and pressure with a single sensing unit. Gas, pressure and temperature sensors that can withstand high temperatures are extremely important for numerous applications that are across many areas.

For instance, oxy-fuel combustion is a carbon capture technology that involves burning fuel in a mixture of oxygen and recycled flue gas at high temperatures and pressures. Being able to monitor the flue gas (CO, CO₂ and O₂) composition and concentration, along with pressure and temperature can provide critical information about the performance and operation of the system, which can help optimize efficiency and reduce emissions.

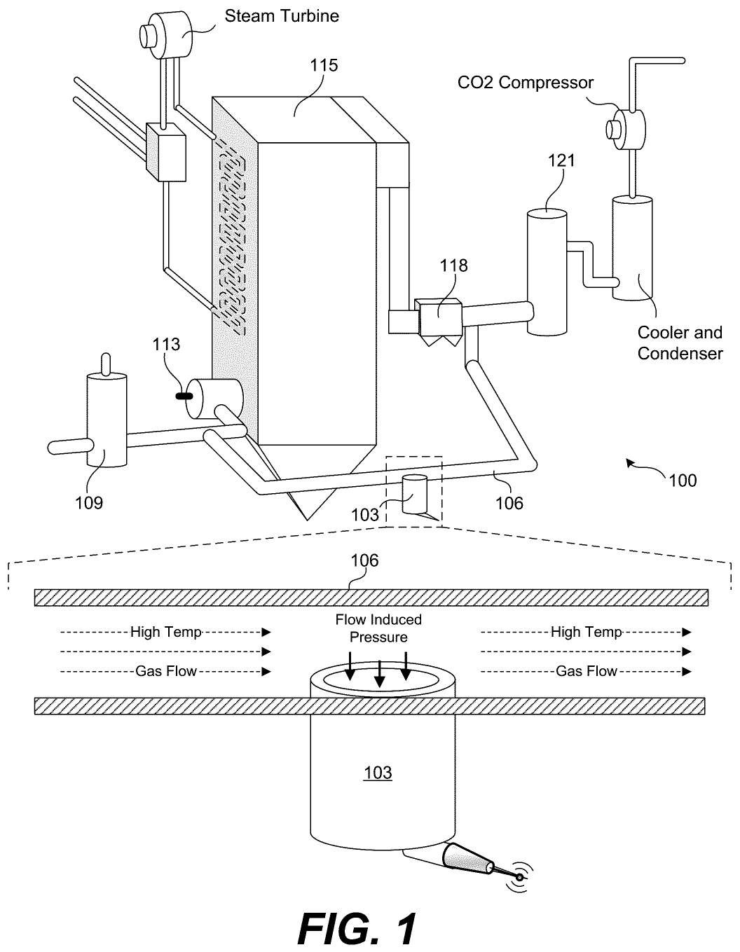

With reference to FIG. 1, shown is an example boiler system 100 that includes a wireless multifunctional harsh environment monitoring device 103. As shown in FIG. 1, the wireless multifunctional harsh environment monitoring device 103 can be installed on the flue gas recirculation pipe 106 of the boiler system 100 or any oxy combustion process that carries high temperature gas mixture (CO, CO₂ and O₂).

The recirculation pipe 106 is shown connecting from a pipe on the fuel and air supply combustion side of the boiler system 100 to a pipe on the exhaust side of the boiler system 100. Specifically, in this example, the recirculation pipe 106 is shown connecting to a first pipe between an air separation component 109 and a fuel injection component 113 of a boiler 115, and a second pipe between a particle removal component 118 and a sulfur removal component 121.

The wireless multifunctional harsh environment monitoring device 103 is connected to the recirculation pipe 106 such that one side or surface of the device is within or exposed to an interior of the hot recirculation pipe 106 and another side or surface of the device is outside of the interior of the recirculation pipe 106. The wireless multifunctional harsh environment monitoring device 103 is used to detect three or more types of gasses. For example, CO, CO₂ and O₂, and other gasses.

High temperature gas flow is shown in a particular direction, but can potentially be in either direction and can change direction during operation in the various embodiments of the disclosure. The gas presence and gas flow can cause pressure against the wireless multifunctional harsh environment monitoring device 103. The wireless multifunctional harsh environment monitoring device 103 can detect the gas induced pressure and temperature simultaneously using a high temperature piezoelectric crystal component. The gasses can be detected using Interdigital Transducer (IDT) based surface acoustic wave (SAW) gas sensors for each gas desired. The SAW gas sensors can include Patterned Piezoelectric films that operate as an IDT and Micro Electronic Mechanical Systems (MEMS) gas detection system. Each of the SAW gas sensors can include a mechanical pattern and material tuned to detect a particular type of gas.

The proposed mechanism can include a dumbbell crystal structure with 3 parts including top and bottom disks and middle rectangular bar. The top circular disk is used to detect three gas species (CO, CO₂ and O₂) using three pairs of IDT (Interdigitated electrode) with three different sensing films that can selectively detect these three gas species. The middle rectangular bar will be used to detect pressure and temperature simultaneously. The dumbbell sensor core will be sealed in a stainless steel housing. With the high temperature antenna, the sensor can communicate with an interrogator. A three-pair IDT with sensing film that are the same as those three at the top of the disk will be deposited on the back side of the vertical rectangular bar, allowing users to calibrate the gas sensor without removing it from the pipe. Once the platinum IDT electrodes are fabricated using photolithography, dedicated high temperature sensing films for each gas can be deposited on the surface of a langasite (LGS) SAW substrate. Each sensing layer is capable of selectively detecting one gas. A calcium doped Zinc oxide, cobalt corroles and Zinc oxide sensing films can be deposited on the surface of the sensors for the detection of CO₂, CO and O₂ respectively. Other gasses can be detected using other materials and structures as can be understood.

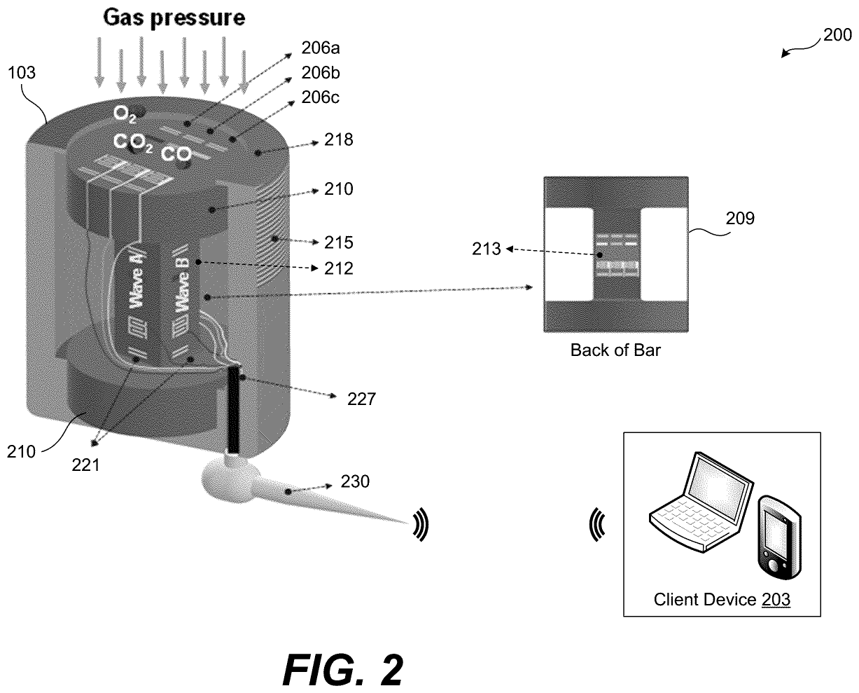

FIG. 2 shows a harsh environment monitoring system 200 that includes a wireless multifunctional harsh environment monitoring device 103 and a client device 203 among other components. The wireless multifunctional harsh environment monitoring device 103 can include a sensor core which is a dumbbell-shaped crystal made of a new high temperature piezoelectric crystal-Langasite (La3Ga5SiO14, or LGS), or another material which can maintain its piezoelectricity up to 1,470° C. This property makes high temperature piezoelectric crystal-Langasite (La3Ga5SiO14, or LGS) very effective for applications in high temperature environments.

The top surface of the sensor core can include multiple gas detection systems 206a, 206b, 206c. Each gas detection system 206 can include an IDT or interdigitated electrode with a sensing film that can selectively detect a gas species or type. The gas detection system 206 can also be considered a SAW gas sensor that includes a patterned piezoelectric or another type of film that operates in conjunction with an IDT in a MEMS gas detection system 206. Each of the SAW gas sensors can include a mechanical pattern and material tuned to detect a particular type of gas.

The wireless multifunctional harsh environment monitoring device 103 can include multiple components. For example, the dumbbell-shaped crystal structure 209 of the wireless multifunctional harsh environment monitoring device 103 can include top and bottom disks 210 and a middle rectangular bar 212. The middle bar 212 can alternatively be cylindrical or any shape with an n-gonal cross section. The disks 210 and the rectangular bar 212 therebetween can be individual but adjacent or connected components, or can be formed as a single dumbbell shaped crystal structure 209 in various examples.

While the top of the dumbbell-shaped crystal structure 209 can be exposed to the interior of a recirculation pipe, the bottom can be encased in a housing 215 that includes an open-topped and closed-bottom shape such as a cylindrical shape that matches a shape of the disks 210. The disks 210 can be circular, such that the housing 215 is cylindrical. However, the disks 210 can be square or rectangular disks and the housing 215 can include an open-topped rectangular prism, and so on. The top diaphragm can also be selected to match the shape of the disks 210 of the dumbbell-shaped crystal structure 209. The top circular disk 210 as shown is used to detect three gas species (CO, CO₂ and O₂) using three pairs of IDT with three different sensing films that can selectively detect these three gas species. The middle rectangular bar 212 can be used to detect pressure and temperature simultaneously.

The dumbbell sensor core can be sealed in a stainless steel or other appropriate housing 215. The dumbbell-shaped crystal structure 209 can be held in place within the housing 215 by a stainless steel ring diaphragm 218 that connects over a top of the top of the dumbbell-shaped crystal structure 209 and affixes to the housing 215. The stainless steel ring diaphragm 218 can leave the gas detection systems 206 exposed on the top of the dumbbell-shaped crystal structure 209.

The middle bar 212 can include a dual mode pressure and temperature sensing mechanism 221 that includes set of two temperature and pressure sensing devices corresponding to “Wave A” and “Wave B” as labelled in the figure. Each of the temperature and pressure sensing devices can include an IDT, a reflector, and a sensing layer. The proposed dual mode pressure and temperature sensing mechanism 221 can use the set of two temperature and pressure sensing devices to account for pressure vs. frequency shift, as confirmed by simulations. The result is that the two waves A and B have different sensitivity and different patterns, which enables the dual mode pressure/temperature sensing of the pressure and temperature sensing mechanism 221.

The middle bar 212 can also include a set of internal gas detection systems 213 that match the gas detection systems 206 exposed to the interior of the recirculation pipe. This internal set of internal gas detection systems 213 enable self-calibration of the gas detection systems 206 to detect the various gasses discussed without removal from the pipe.

A high temperature antenna 230 enables the wireless multifunctional harsh environment monitoring device 103 to communicate with an interrogator or client device 203 that includes software for visualization and display of gas types, gas levels, temperature, and pressure detected using the wireless multifunctional harsh environment monitoring device 103.

A high temperature antenna 230 can include components capable of wireless communications over one or more local area networks or wide area networks. Local area networks can include peer-to-peer and other direct communications between two devices. Wireless transmission components 109 can include devices capable of generating or communicating over cellular networks, satellite networks, Institute of Electrical and Electronic Engineers (IEEE) 802.11 wireless networks (i.e., WI-FI®), BLUETOOTH® networks, Zigbee® networks, microwave transmission networks, as well as other networks relying on radio broadcasts. For example, the wireless transmission components 109 can include wireless chips such as Xbee® 3 or Xbee-Pro® (footprint ˜1″×1″, 4000 Ft or 1.2 km, 40 mA @ 3.3V, 250 Kbps), which can communicate with a computing device of the parameter monitoring service 112. This can include a display that shows a readout in a control room of a facility, such as a power generation facility, an industrial facility, a medical facility, and so on depending on the application of the wireless multifunctional harsh environment monitoring device 103.

The client device 203 can include a parameter monitoring service 112 that is located locally or remotely. The parameter monitoring service 112 can generate and output parameters such as, for example, gas levels, temperature, and pressure detected using the wireless multifunctional harsh environment monitoring device 103. The parameter monitoring service can include a display, and can show the parameter outputs as well as a history of the density and level on the display. The historical datapoints can be graphed to show a change of the parameters over time, calculate an average, median, or moving average over a specified time chunk and so on. The parameter monitoring service can also provide these parameter outputs to control systems that provide notifications to administrators, engineers, and other users to alert them to operating conditions. The user interface and/or the notification can indicate an action to take in response to the parameters, such as an indication to service the battery, power generation, boiler ignition system, medical, or other electrode device. In some examples, the control systems that receive parameters from the parameter monitoring service can make automatic adjustments such as stopping or modifying a boiler system ignition, valve, fane, or otherwise affecting a gas flow through the recirculation pipe.

The parameter monitoring service can include instructions that map the pressures received from the wireless multifunctional harsh environment monitoring device 103 to the output parameters. The output parameters can also be mapped to specified actions such as transmitting a notification or transmitting a subset of the parameters as a notification or instructions to provide rectifying or corrective action.

The parameter monitoring service can be executed using one or more computing devices that are in wired and/or wireless communications with the wireless multifunctional harsh environment monitoring device 103. For example, the parameter monitoring service can include a cloud-based service that is accessible over a public wide area network such as the Internet. The parameter monitoring service can include a service that is hosted privately and is accessible over a private wide area network, or a local area network.

The high temperature antenna 230 can be designed and fabricated to withstand the extreme environment and to ensure reliable communication between the wireless multifunctional harsh environment monitoring device 103 and the interrogator service that provides a user interface on a client device 203. The client device 203 and can include a transceiver and a digital signal processor that can be controlled and used by the interrogator service. The transceiver can include a built-in transmitter and a receiver. The digital signal processor can control the operation of transmitting and receiving. The interrogator service can use the digital signal processor to perform the spectral analysis of the SAW response, and calculate the gas concentration, pressure and temperature, as well as provide the output parameters, notifications, programmatically applied actions, and timestamped history of parameters as discussed.

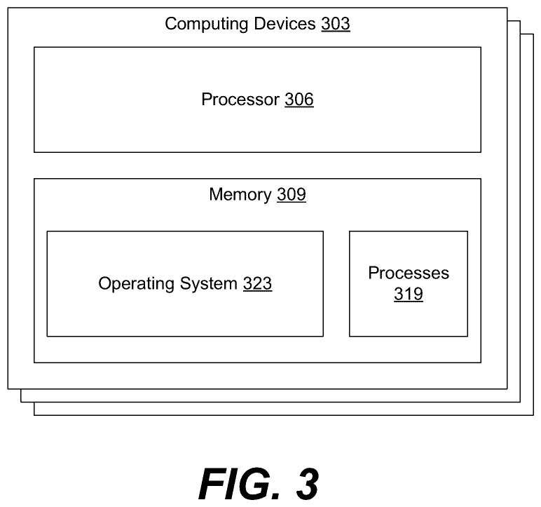

FIG. 3 depicts a schematic block diagram of one example of one or more computing devices 303 for the components of the networked environment of FIG. 1, according to various embodiments of the present disclosure. A computing device 303 can have one or more processors 306. The computing device 303 can also have a memory 309.

The processor 306 can represent any circuit or combination of circuits that can execute one or more machine-readable instructions stored in the memory 309 that make up a computer program or process and store the results of the execution of the machine-readable instructions in the memory 309. In some implementations, the processor 306 may be configured to perform one or more machine-readable instructions in parallel or out of order. This could be done if the processor 306 includes multiple processor cores and/or additional circuitry that supports simultaneous multithreading (SMT). Examples of a processor 306 can include a central processing unit (CPU), a graphics processing unit (GPU), a field-programmable gate array (FPGA), application specific integrated circuits (ASICs), etc.

The memory 309 can include both volatile and nonvolatile memory and data storage components. Volatile components are those that do not retain data values upon loss of power. Nonvolatile components are those that retain data upon a loss of power. Thus, the memory 309 can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device. Various types of data and machine-readable instructions may be stored in the memory 309. For example, one or more processes 319 may be stored in the memory 309. In some implementations, an operating system 323 may also be stored in the memory 309.

A process 319 can represent a collection of machine-readable instructions stored in the memory 309 that, when executed by the processor 306 of the computing device 303, cause the computing device 303 to perform one or more tasks. A process 319 can represent a program, a sub-routine or sub-component of a program, a library used by one or more programs, etc. When a process requests access to a hardware or software resource for which it lacks permission to interact with, the process 319 can generate an interrupt and provide or send the interrupt to the operating system 323.

The operating system 323 can include any system software that manages the operation of computer hardware and software resources of the computing device 303. The operating system 323 can also provide various services or functions to computer programs, such as processes 319, that are executed by the computing device 303. Accordingly, the operating system 323 may schedule the operation of tasks or processes 319 by the processor 306, act as an intermediary between processes 319 and hardware of the computing device 303. The operating system 323 may also implement and/or enforce various security safeguards and mechanisms to prevent access to hardware or software resources by unprivileged or unauthorized users or processes 319.

The operating system 323 can also implement a virtual memory system that provides an abstract representation of the memory 309 available on the computing device 303, such as the RAM. Among the features provided by the virtual memory system are a per process 319 address space, which maps virtual addresses used by a process 319 to physical addresses of the memory 309. The processor's memory management unit (MMU) can translate these virtual addresses to physical addresses, when used. The operating system 323 can use the virtual memory system to present more memory 309 to individual processes 319 than is physically available.

A number of software components discussed can be stored in the memory of computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), persistent memory, hard drive, solid-state drive, Universal Serial Bus (USB) flash drive, memory card, optical disc such as compact disc (CD) or digital versatile disc (DVD), floppy disk, magnetic tape, or other memory components.

Memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, graphics processing units (GPUs), field-programmable gate arrays (FPGAs), or other components, etc. Such technologies are generally well known by those skilled in the art and, consequently, are not described in detail herein.

Flowcharts may be used to describe the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although flowcharts can show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Illustrative examples of various embodiments of the present disclosure are set forth below. Additional embodiments of the present disclosure are discussed in the preceding paragraphs. Accordingly, the scope of the present disclosure should not be construed as being limited to the following clauses:

Clause 1—A multifunctional harsh environment gas monitoring device, comprising a housing; a dumbbell-shaped crystal structure within the housing, the dumbbell-shaped crystal structure comprising a top disk a bottom disk and a center bar between the top disk and the bottom disk; a plurality of gas detection systems comprising at least one component exposed on a surface of the top disk of the dumbbell-shaped crystal structure and open to an open top of the housing; and a pressure and temperature sensing mechanism attached to the center bar of the dumbbell-shaped crystal structure, wherein the pressure and temperature sensing mechanism simultaneously detects pressure and temperature from at least one gas exposed to the surface of the top disk of the dumbbell-shaped crystal structure and the plurality gas detection systems detect material content of the at least one gas.

Clause 2—The multifunctional harsh environment gas monitoring device of clause 1, wherein a respective one of the plurality of the gas detection systems includes an interdigital transducer (IDT) electrode and a high temperature sensing film for a particular one of a plurality of gasses detected using the plurality of gas detection systems.

Clause 3—The multifunctional harsh environment gas monitoring device of clause 1, wherein the multifunctional harsh environment gas monitoring device is mounted to a gas recirculation pipe.

Clause 4—The multifunctional harsh environment gas monitoring device of clause 3, wherein the surface of the top disk of the dumbbell-shaped crystal structure is exposed to an interior of the gas recirculation pipe.

Clause 5—The multifunctional harsh environment gas monitoring device of clause 1, wherein the plurality of the gas detection systems detect Oxygen, Carbon Dioxide, and Carbon monoxide.

Clause 6—The multifunctional harsh environment gas monitoring device of clause 1, wherein the pressure and temperature sensing mechanism comprises two pressure and temperature sensing devices.

Clause 7—The multifunctional harsh environment gas monitoring device of clause 6, wherein the two pressure and temperature sensing devices are mounted orthogonally relative to one another on the center bar.

Clause 8—The multifunctional harsh environment gas monitoring device of clause 1, wherein the center bar comprises a plurality of internal gas detection systems that match the gas detection systems exposed on the surface of the top disk, and the internal gas detection systems enable calibration of the gas detection systems.

Clause 9—The multifunctional harsh environment gas monitoring device of clause 1, wherein the center bar comprises a plurality of internal gas detection systems that match the gas detection systems exposed on the surface of the top disk, and the internal gas detection systems enable calibration of the gas detection systems.

Clause 10—The multifunctional harsh environment gas monitoring device of clause 1, further comprising a high temperature antenna in wireless communication with an interrogator service that generates a user interface that shows a plurality of parameters detected using the multifunctional harsh environment gas monitoring device.

Clause 11—A multifunctional harsh environment gas monitoring device, comprising a housing; a piezoelectric crystal component within the housing, the piezoelectric crystal component comprising a first plate, a second plate, and a center bar disposed between the first plate and the second plate; at least one gas sensor disposed on a surface of the first plate of the piezoelectric crystal component and exposed through an opening in the housing, the at least one gas sensor configured to detect material content of at least one gas exposed through the opening in the housing; and a pressure and temperature sensing mechanism disposed on the center bar of the piezoelectric crystal component, the pressure and temperature sensing mechanism configured to simultaneously detect pressure and temperature from the at least one gas.

Clause 12—The multifunctional harsh environment gas monitoring device of clause 11, wherein the at least one gas sensor comprises an Interdigital Transducer (IDT) based surface acoustic wave (SAW) gas sensor.

Clause 13—The multifunctional harsh environment gas monitoring device of clause 12, wherein the at least one gas sensor includes one or more patterned piezoelectric films configured to operate as an IDT and a micro electronic mechanical gas detection system.

Clause 14—The multifunctional harsh environment gas monitoring device of clause 11, wherein the pressure and temperature sensing mechanism further comprises a first temperature and pressure sensing device; and a second temperature and pressure sensing device, wherein each of the first and second temperature and pressure sensing devices comprises an IDT, a reflector, and a sensing layer.

Clause 15—The multifunctional harsh environment gas monitoring device of clause 11, further comprising a high temperature antenna disposed on an exterior surface of the housing.

Clause 16—The multifunctional harsh environment gas monitoring device of clause 15, wherein the high temperature antenna is in wireless communication with an interrogator service that generates a user interface that shows a plurality of parameters detected using the multifunctional harsh environment gas monitoring device.

Clause 17—The multifunctional harsh environment gas monitoring device of clause 11, wherein the center bar further comprises a plurality of internal gas detection systems configured to enable calibration of the at least one gas sensor.

Clause 18—A multifunctional harsh environment gas monitoring device, comprising a housing having an opening on a first end; a crystal component disposed the housing, the piezoelectric crystal component comprising a first end, a second end, and a center portion disposed between the first end and the second end; one or more gas sensors disposed on a surface of the first end of the crystal component and exposed through an opening in the housing; a pressure sensing mechanism disposed on the center portion of the crystal component; and a temperature sensing mechanism disposed on the center portion of the crystal component adjacent to the pressure sensing mechanism.

Clause 19—The multifunctional harsh environment gas monitoring device of clause 18, wherein the one or more gas sensors further comprises a first pair of IDT electrodes with a first sensing film; a second pair of IDT electrodes with a second sensing film; and a third pair of IDT electrodes with a third sensing film, wherein each of the first sensing film, the second sensing film, and the third sensing film is configured to detect a different gas.

Clause 20—The multifunctional harsh environment gas monitoring device of clause 18, wherein the crystal component further comprises a dumbbell-shaped piezoelectric crystal-Langasite component which maintains its piezoelectricity up to approximately 1470° C.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. While concepts of the present disclosure are discussed with respect to a particular figure, the concepts can also be used in connection with the other figures. All such modifications and variations are intended to be included herein within the scope of this disclosure and protected by the following claims.

Therefore, the following is claimed:

1. A multifunctional harsh environment gas monitoring device, comprising:
a housing;
a dumbbell-shaped crystal structure within the housing, the dumbbell-shaped crystal structure comprising a top disk, a bottom disk, and a center bar between the top disk and the bottom disk;
a plurality of gas detection systems comprising at least one component exposed on a surface of the top disk of the dumbbell-shaped crystal structure and open to an open top of the housing; and
a pressure and temperature sensing mechanism attached to the center bar of the dumbbell-shaped crystal structure, wherein the pressure and temperature sensing mechanism simultaneously detects pressure and temperature from at least one gas exposed to the surface of the top disk of the dumbbell-shaped crystal structure and the plurality gas detection systems detect material content of the at least one gas.

2. The multifunctional harsh environment gas monitoring device of claim 1, wherein a respective one of the plurality of the gas detection systems includes an interdigital transducer (IDT) electrode and a high temperature sensing film for a particular one of a plurality of gasses detected using the plurality of gas detection systems.

3. The multifunctional harsh environment gas monitoring device of claim 1, wherein the multifunctional harsh environment gas monitoring device is mounted to a gas recirculation pipe.

4. The multifunctional harsh environment gas monitoring device of claim 3, wherein the surface of the top disk of the dumbbell-shaped crystal structure is exposed to an interior of the gas recirculation pipe.

5. The multifunctional harsh environment gas monitoring device of claim 1, wherein the plurality of the gas detection systems detect Oxygen, Carbon Dioxide, and Carbon monoxide.

6. The multifunctional harsh environment gas monitoring device of claim 1, wherein the pressure and temperature sensing mechanism comprises two pressure and temperature sensing devices.

7. The multifunctional harsh environment gas monitoring device of claim 6, wherein the two pressure and temperature sensing devices are mounted orthogonally relative to one another on the center bar.

8. The multifunctional harsh environment gas monitoring device of claim 1, wherein the center bar comprises a plurality of internal gas detection systems that match the gas detection systems exposed on the surface of the top disk, and the internal gas detection systems enable calibration of the gas detection systems.

9. The multifunctional harsh environment gas monitoring device of claim 1, wherein the center bar comprises a plurality of internal gas detection systems that match the gas detection systems exposed on the surface of the top disk, and the internal gas detection systems enable calibration of the gas detection systems.

10. The multifunctional harsh environment gas monitoring device of claim 1, further comprising a high temperature antenna in wireless communication with an interrogator service that generates a user interface that shows a plurality of parameters detected using the multifunctional harsh environment gas monitoring device.

11. A multifunctional harsh environment gas monitoring device, comprising:
a housing;
a piezoelectric crystal component within the housing, the piezoelectric crystal component comprising a first plate, a second plate, and a center bar disposed between the first plate and the second plate;
at least one gas sensor disposed on a surface of the first plate of the piezoelectric crystal component and exposed through an opening in the housing, the at least one gas sensor configured to detect material content of at least one gas exposed through the opening in the housing; and
a pressure and temperature sensing mechanism disposed on the center bar of the piezoelectric crystal component, the pressure and temperature sensing mechanism configured to simultaneously detect pressure and temperature from the at least one gas.

12. The multifunctional harsh environment gas monitoring device of claim 11, wherein the at least one gas sensor comprises an Interdigital Transducer (IDT) based surface acoustic wave (SAW) gas sensor.

13. The multifunctional harsh environment gas monitoring device of claim 12, wherein the at least one gas sensor includes one or more patterned piezoelectric films configured to operate as an IDT and a micro electronic mechanical gas detection system.

14. The multifunctional harsh environment gas monitoring device of claim 11, wherein the pressure and temperature sensing mechanism further comprises:
a first temperature and pressure sensing device; and
a second temperature and pressure sensing device, wherein each of the first and second temperature and pressure sensing devices comprises an IDT, a reflector, and a sensing layer.

15. The multifunctional harsh environment gas monitoring device of claim 11, further comprising a high temperature antenna disposed on an exterior surface of the housing.

16. The multifunctional harsh environment gas monitoring device of claim 15, wherein the high temperature antenna is in wireless communication with an interrogator service that generates a user interface that shows a plurality of parameters detected using the multifunctional harsh environment gas monitoring device.

17. The multifunctional harsh environment gas monitoring device of claim 11, wherein the center bar further comprises a plurality of internal gas detection systems configured to enable calibration of the at least one gas sensor.

18. A multifunctional harsh environment gas monitoring device, comprising:
a housing having an opening on a first end;
a crystal component disposed the housing, the piezoelectric crystal component comprising a first end, a second end, and a center portion disposed between the first end and the second end;
one or more gas sensors disposed on a surface of the first end of the crystal component and exposed through an opening in the housing;
a pressure sensing mechanism disposed on the center portion of the crystal component; and
a temperature sensing mechanism disposed on the center portion of the crystal component adjacent to the pressure sensing mechanism.

19. The multifunctional harsh environment gas monitoring device of claim 18, wherein the one or more gas sensors further comprises:
a first pair of IDT electrodes with a first sensing film;
a second pair of IDT electrodes with a second sensing film; and
a third pair of IDT electrodes with a third sensing film, wherein each of the first sensing film, the second sensing film, and the third sensing film is configured to detect a different gas.

20. The multifunctional harsh environment gas monitoring device of claim 18, wherein the crystal component further comprises a dumbbell-shaped piezoelectric crystal-Langasite component which maintains its piezoelectricity up to approximately 1470° C.
